(19) United States
(12) Patent Application Publication
(10) Pub. No.: US 2025/0000286 A1
(43) Pub. Date: Jan. 2, 2025

(54) CONTAINER

(71) Applicant: NOVELLI INC., Chicago, IL (US)

(72) Inventors: Louis Samuels, Zionsville, IN (US); Craig Pinker, Auckland (NZ)

(21) Appl. No.: 18/791,458

(22) Filed: Aug. 1, 2024

Related U.S. Application Data
(63) Continuation-in-part of application No. 18/215,169, filed on Jun. 27, 2023.

(51) Int. Cl. A47G 19/22; A63H 33/08; G09F 23/08

(52) U.S. Cl. CPC A47G 19/2227; A47G 19/2255; A63H 33/086; G09F 23/08

(57) ABSTRACT

A cup with an internal sleeve, and an external decorative sleeve made of connector bricks and a base. The internal sleeve has a hollow interior to form a cup to contain liquids if desired. The internal sleeve has a first end and a second end, and a first connector at the second end. The base has a second connector for connecting the base to the first connector of the sleeve. The external decorative sleeve is defined by a plurality of clamp bricks having a first bed with studs, and a second bed with recesses, the studs being capable of receipt into the recesses to interconnect the bricks to form an external decorative sleeve. The invention also includes the method of assembling and disassembling the cup into the internal sleeve, the base and the bricks.

### RELATED APPLICATIONS

This application is a continuation-in-part of U.S. application Ser. No. 18/215,169 filed Jun. 27, 2023, which is incorporated herein by reference in its entirety.

### TECHNICAL FIELD

This invention relates generally to cups or containers and more specifically to a novelty cup that can be assembled by the user.

### BACKGROUND OF THE INVENTION

It is desirable to provide a cup that is not only capable for holding something, like objects, such as pens and pencils or liquids but also to provide entertainment for the user by allowing the user to assemble and disassemble the cup.

### SUMMARY OF THE INVENTION

In general terms, this invention provides a cup that is functional and entertaining. The cup has a sleeve with a hollow interior, a first end and a second end, and a first connector at the second end. A base has a second connector for connecting the base to the first connector of the sleeve. An external decorative sleeve is positioned over the sleeve. The external decorative sleeve is created from a plurality of clamp bricks having a first bed with studs, and a second bed with recesses, the studs are inserted into the recesses to interconnect the bricks to form the external decorative sleeve.

The cup in the disclosed embodiment has a sleeve with a rim at the first end. The rim as disclosed includes a recess for accepting the top row of clamp bricks. As disclosed, the first and second connectors are threaded and mate together to connect the sleeve to the base. The sleeve can also include a handle.

The clamp bricks as shown in the drawings have internal and external stretcher faces with the internal and external stretcher faces being curved. The stretcher faces can also include an image on at least one of said clamp bricks.

A method of assembling a cup is disclosed that includes providing a plurality of clamp bricks having a first bed with studs, and a second bed with recesses, the studs being capable of receipt into the recesses to interconnect the bricks to form an external decorative sleeve. Assembling the bricks to form the outer sleeve includes the steps of creating a starter course of clamp bricks on the base by selecting clamp bricks from the plurality of clamp bricks, positioning a brick over the studs, and inserting the studs into the recesses and repeating until the starter course is complete. Then creating a course of bricks over the starter course by selecting clamp bricks from the plurality of clamp bricks, positioning a brick over the studs of the bricks in the starter course and inserting the studs into the recesses and repeating until that course is complete. This process is repeated to create courses of bricks until the decorative external sleeve is assembled. The internal sleeve is inserted in the decorative external sleeve and connected to the base.

In the disclosed embodiment, the first and second connectors are threaded and the step of connecting the base to the sleeve includes the step of threading the first and second connectors together.

In the disclosed embodiment, the sleeve has a rim, and the rim has a recess. The step of inserting the sleeve into the external sleeve includes the step of inserting the uppermost bricks of the external sleeve into the recess.

The external sleeve can also include images and the step of assembling the bricks includes selecting and positioning bricks with partial images to correctly form the full image.

The bricks can be assembled in a running bond style wherein the bricks are staggered by ½ brick from the course above and below, in an one-over-two pattern. They can also have other arrangements, such as for example the stack bond where the stretcher bricks are laid in a grid of identical courses. In the stack bond, the joints are not staggered between courses.

To disassemble the cup, the sleeve is disconnected from the base. As disclosed, the sleeve is twisted to unthread the internal threads from the external threads. The sleeve is then removed from the decorative external sleeve. The bricks can be disassembled by removing the studs from the recesses.

These and other features and advantages of this invention will become more apparent to those skilled in the art from the detailed description of a preferred embodiment.

The drawings that accompany the detailed description are described below.

### BRIEF DESCRIPTION OF THE DRAWINGS

FIG. 1 is a perspective view of a first embodiment of the cup.

FIG. 2 is a perspective view of a second embodiment of the cup.

FIG. 3 is a cross section taken along 3-3 of FIG. 1.

FIG. 4 is a cross section taken along 4-4 of FIG. 2.

FIG. 5 is an exploded view of the first embodiment.

FIG. 6 is an exploded view of the second embodiment.

FIG. 7 is a perspective view of the cup partially assembled.

FIG. 8 is an exploded view of the cup of FIG. 7.

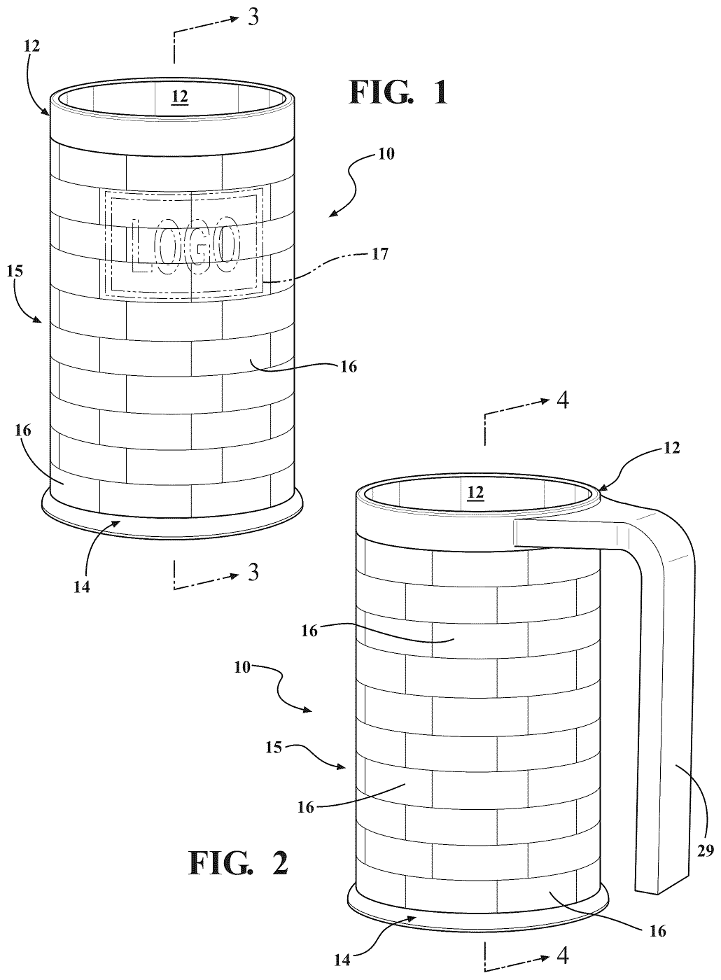

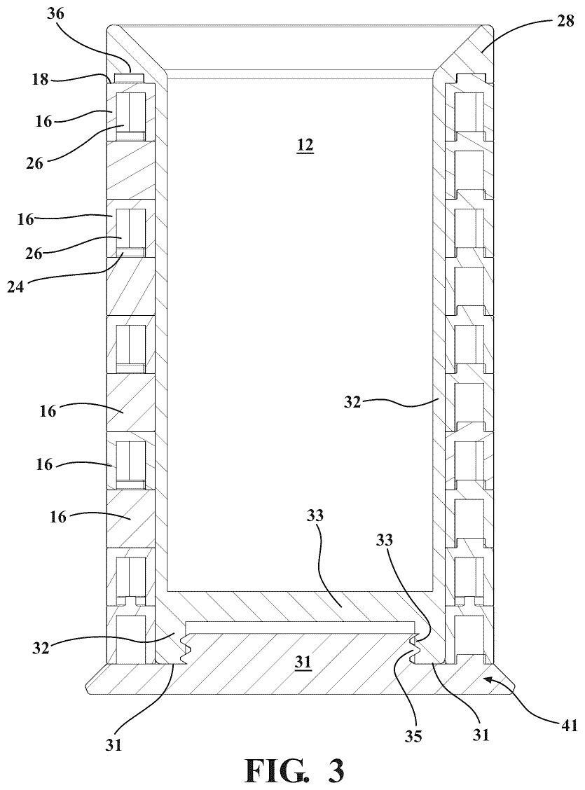

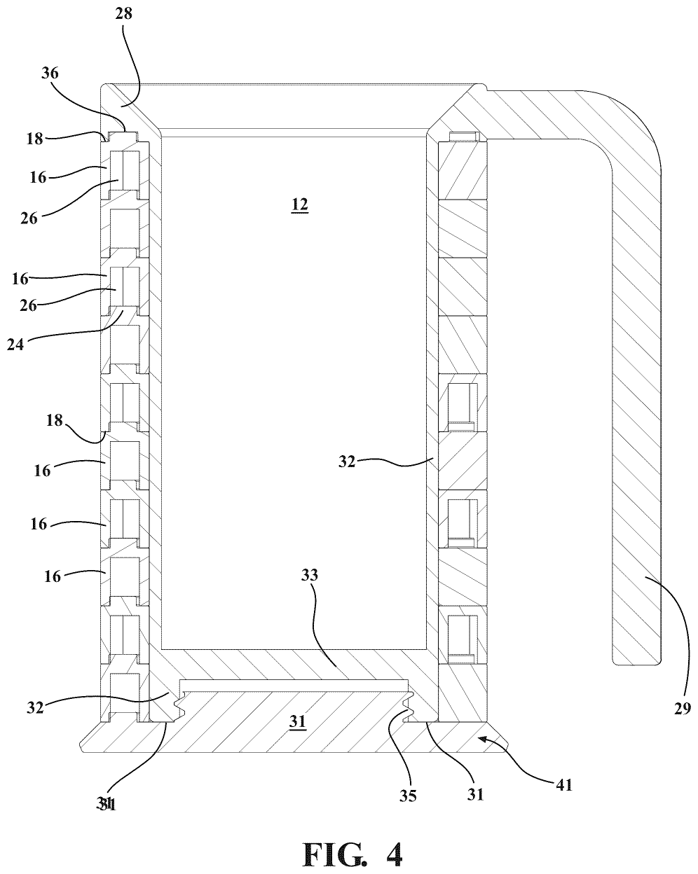

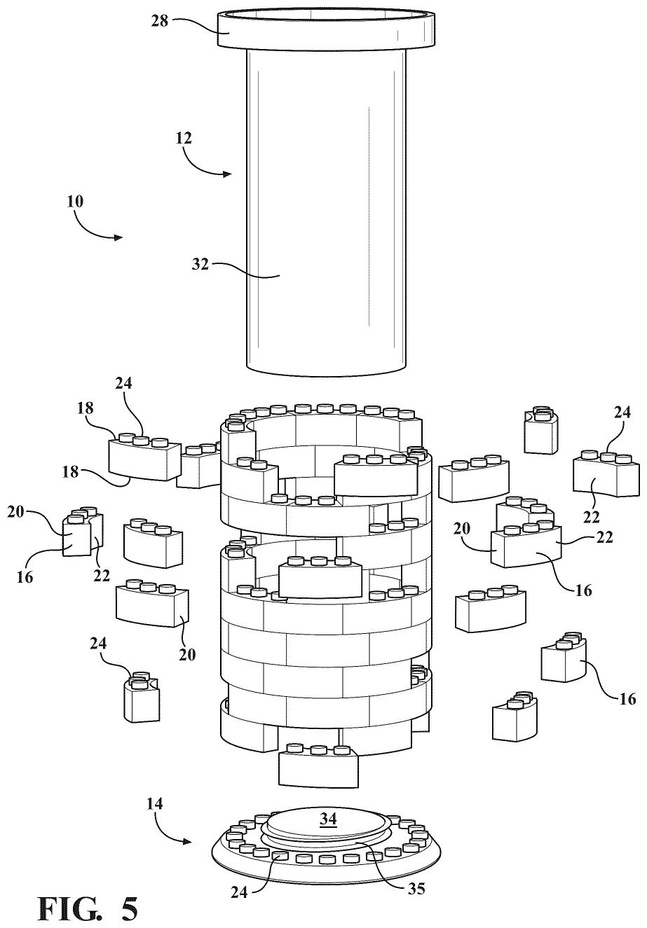

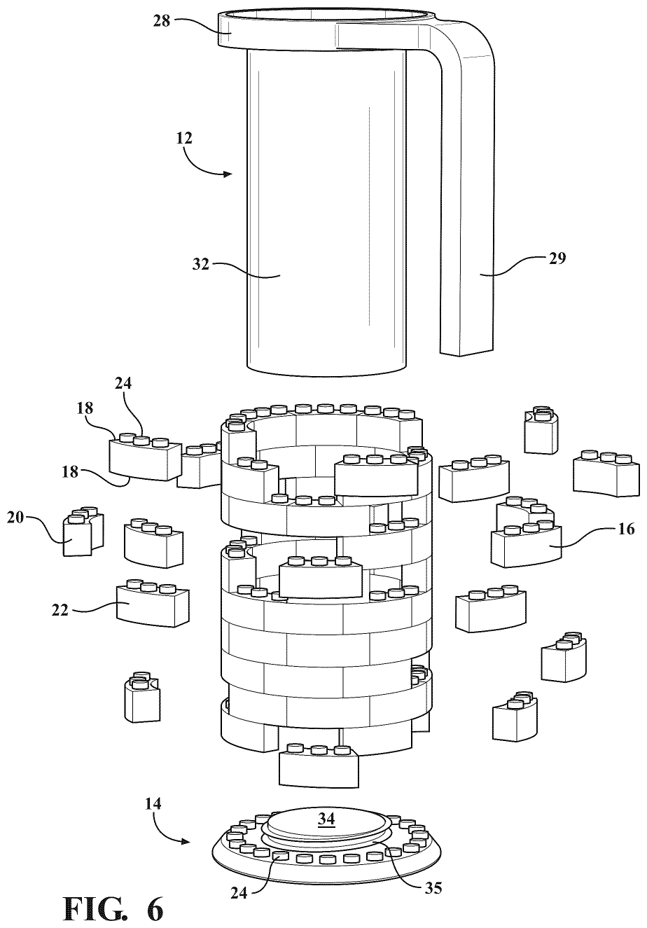

### DETAILED DESCRIPTION OF A PREFERRED EMBODIMENT

The novelty container or cup of the present invention is shown generally at 10. The cup has an internal sleeve 12 a base 14 and clamp bricks 16 which can be interconnected to form a decorative external sleeve 15 that fits over the internal sleeve 12.

Clamp bricks 16 are assembled to create the decorative external sleeve 15. The bricks 16 as disclosed are made of molded plastic and have top and bottom beds 18, ends or header faces 20 and sides or stretcher faces 22. As illustrated the stretcher faces 22 are radial stretcher faces wherein the stretcher faces are curved in a mirror like fashion. It should be understood that the outer stretcher face 22 could be flat i.e., not radiused to provide a different appearance. For example, the outside stretcher face could be flat to create a box like structure or have other shapes to create, for example, raised surfaces or triangular surfaces, etc. The outer stretcher faces could also have images 17 on them that require the pieces to be correctly positioned to create the image, like a puzzle. The image could be any type of image including a corporate logo for example.

The beds 18 of the clamp bricks 16 have studs 24 protruding from one bed 18 and mating recesses 26 in the opposite bed 18 so that the clamp bricks 16 can be interconnected to form a unitary decorative external sleeve 15.

The sleeve 12 includes a rim 28 and body 30. As shown in FIGS. 2,4, and 6, the rim can also include a handle 29. The free end 31 of the body 30 has a first connector 32 which connects with a second connector 34 to join the sleeve 12 with the base 14. As illustrated, the sleeve 12 has a bottom 33 spaced from the opposed end 31. In the disclosed embodiment, the first connector 32 has internal threads 33 for threading onto the second connector 34 on base 14. The connector 34 on base 14 has external threads 35 on second connector 34 which mates with the internal threads of connector 32.

Other types of connectors can be used, for example, a snap fit or fiction fit connection could be used to connect the sleeve 12 to the base 14. In addition, the connectors 32 and 34 could have the threads 33 and 35 reversed. The threads 33 could be on the outside of the sleeve 12 and the second connector 34 could have internal threads 35.

As disclosed, the rim 28 on the sleeve 12 has a recessed portion 36 which receives the studs 24 of the clamp bricks 16 adjacent the rim 28 when the cup or container 10 is assembled. The width of the recess 36 is slightly larger than studs 24 so that the clamp bricks 16 can be inserted into the recessed portion 36 of rim 28 for a clean or more finished look.

The base 14 has a series of studs 24 positioned in a circular pattern to receive the recesses 26 in the adjacent beds 18 of the clamp bricks 16.

To assemble the cup or container 10, the user selects clamp bricks 10 and clamps them to the base 14. As illustrated, the starter course of the bricks 10 would be positioned over the studs 24 and the studs 24 inserted into the corresponding recesses 26. The second layer of bricks 10 would be assembled over the starter course and the process repeated until the decorative external sleeve 15 is completed. It should be appreciated that with images on the decorative external sleeve 15, the correct bricks would need to be selected and positioned correctly for the logo to correctly appear. It should also be appreciated that the bricks 16 as shown are in the running bond style where the bricks are staggered by ½ brick from the course above and below, in a classic one-over-two pattern. They can also have other arrangements, such as for example the stack bond where the stretcher bricks are laid in a grid of identical courses. In the stack bond, the joints are not staggered between courses.

Once the bricks are laid, the sleeve 12 is inserted into the external sleeve 15 and connected to the base 14. As disclosed, the sleeve 12 is inserted and twisted to thread the internal threads 33 onto the external threads 35. As disclosed, the studs 24 of the top bricks are received into the recessed portion 36 of the rim 28.

To disassemble, the sleeve 12 is disconnected from the base 14. As disclosed, the sleeve is twisted to unthread the internal threads 33 from the external threads 35. The sleeve 12 is removed from the decorative external sleeve 15. The bricks 16 can then be disassembled by removing the studs 24 from the recesses 26.

It should be appreciated by those of ordinary skill in this art that the overall shape of the cup or container 10 could be different than the tubular shape shown. The shape could for example be square, rectangular, triangular, oblong, etc.

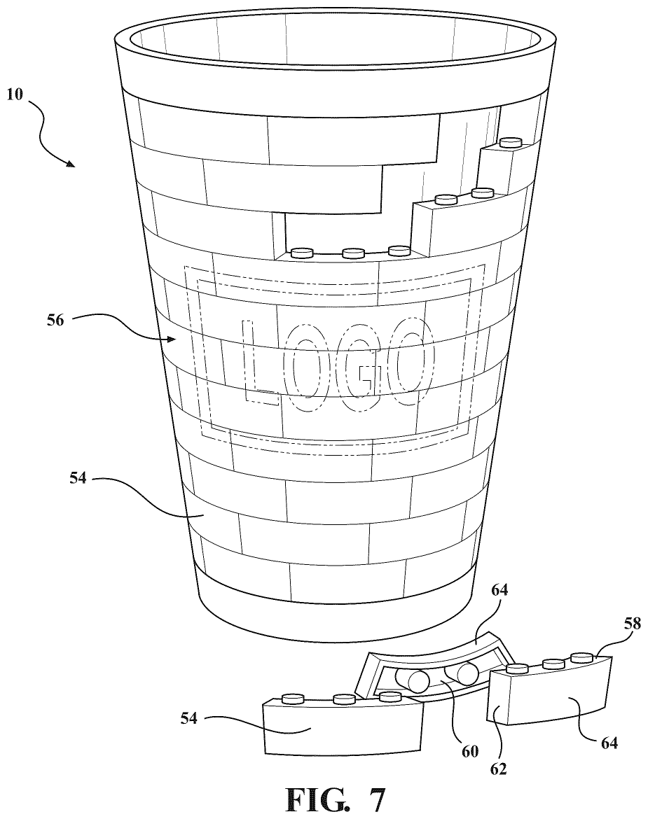

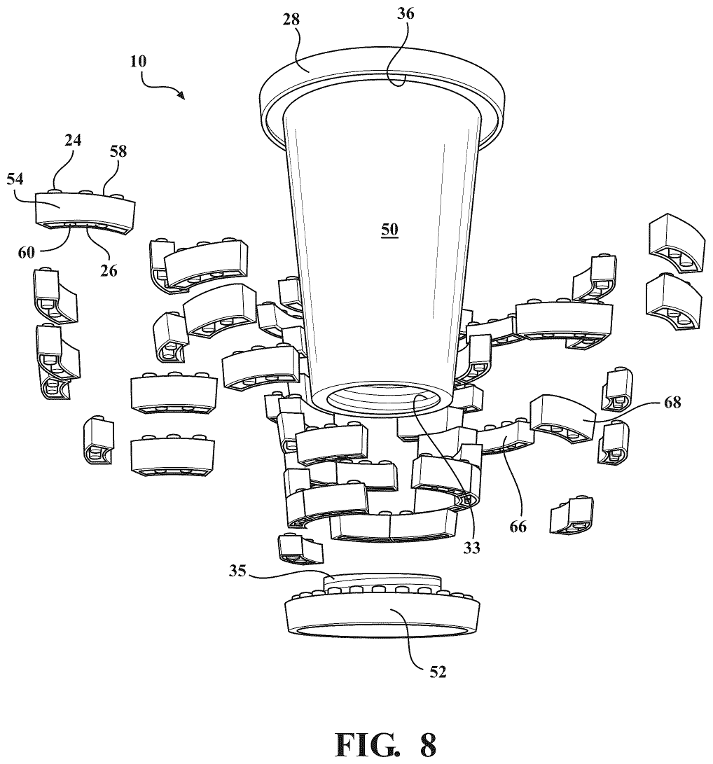

With reference to FIGS. 7 and 8, a further embodiment of the container 10 of the present invention is illustrated. In this embodiment, the container 10 is tapered providing a more complex shape and the clamp bricks 54 have a more complex shape.

In this embodiment, each row of bricks 54 must be molded from a separate mold since the shape changes on each row due to the taper. This tapered shape also creates challenges with printed bricks to get the correct quantity into each product pack. Assembling the outer sleeve is also a challenge because you need to have the inner correct dimensions per level. The challenge to assemble is even greater when there are images that must be correctly matched.

The novelty container or cup 10 illustrated in FIGS. 7 and 8 has a tapered internal sleeve 50 a base 52 and tapered clamp bricks 54 which can be interconnected to form a decorative external sleeve 56 that fits over the internal sleeve 50.

Clamp bricks 54 are assembled to create the decorative external sleeve 56. The bricks 54 as disclosed are made of molded plastic and have top beds 58 and bottom beds 60, ends or header faces 62 and sides or stretcher faces 64.

The beds 18 of the clamp bricks 16 have studs 24 protruding from one bed 58 and mating recesses 26 in the opposite bed 60 so that the clamp bricks 16 can be interconnected to form a unitary decorative external sleeve 56.

As illustrated, the stretcher faces 64 are radial stretcher faces wherein the stretcher faces are curved in a smooth arc fashion with the inner surface 66 being concave and the outer surface 68 being convex. The inner surface 66 and outer surface 68 are also tapered between the top beds 58 and bottom beds 60. The ends or header faces 62 are also angled inwardly from the outer surface 68 to the inner surface 66.

To assemble the cup or container 10, the user selects clamp bricks 54 and clamps them to the base 52. As illustrated, the starter course of the bricks 54 would be positioned over the studs 24 and the studs 24 inserted into the corresponding recesses 26. The second layer of bricks 54 would be assembled over the starter course and the process repeated until the decorative tapered external sleeve 56 is completed. The correct bricks 54 must be selected for the specific row to complete the tapered external sleeve 56. This is due to the taper of each brick 54 of each row being different. As will be appreciated, the bricks 54 must be molded in a separate mold for each row, again due to the taper. It should be appreciated that with images on the decorative tapered external sleeve 56, the correct bricks would need to be selected and positioned correctly for the logo to correctly appear.

It should further be appreciated that the bricks 54 as shown are in the running bond style where the bricks are staggered by ½ brick from the course above and below, in a classic one-over-two pattern. They can also have other arrangements, such as for example the stack bond where the stretcher bricks are laid in a grid of identical courses. In the stack bond, the joints are not staggered between courses.

Once the bricks are laid, the sleeve 50 is inserted into the external sleeve 56 and connected to the base 52. As disclosed, the sleeve 50 is inserted and twisted to thread the internal threads 33 onto the external threads 35. As disclosed, the studs 24 of the top bricks are received into the recessed portion 36 of the rim 28.

To disassemble, the sleeve 50 is disconnected from the base 52. As disclosed, the sleeve is twisted to unthread the internal threads 33 from the external threads 35. The sleeve 50 is removed from the decorative external sleeve 56. The bricks 54 can then be disassembled by removing the studs 24 from the recesses 26.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A cup comprising:
a sleeve having a hollow interior, a first end and a second end, and a first connector at said second end;
a base having a second connector for connecting said base to said first connector of said sleeve;
an external decorative sleeve defined by a plurality of clamp bricks having a first bed with studs, and a second bed with recesses, said studs being configured for insertion into said recesses to interconnect said bricks to form said external decorative sleeve;
said clamp bricks have an inner stretcher face and an outer stretcher face with said inner stretcher face being concave and said external stretcher face being convex, said inner stretcher case and outer stretcher face also being tapered between said first bed and second bed.

2. The cup of claim 1, wherein said sleeve has a rim at said first end.

3. The cup of claim 2, wherein said rim has a recess capable of accepting said studs of said clamp bricks.

4. The cup of claim 1, wherein said first and second connectors are threaded and mate together to connect said sleeve to said base.

5. The cup of claim 1, further including an image on at least one of said clamp bricks.

6. The cup of claim 5, further including an image on said external stretcher face of at least one of said clamp bricks.

7. The cup of claim 1, wherein said sleeve and said decorative external sleeve are tubes.

8. The cup of claim 1, wherein said clamp bricks each have opposed ends, said opposed ends are angled inwardly from said outer stretcher face to said inner stretcher face.

9. A method of assembling a cup comprising the steps of:
providing a sleeve having a hollow interior, a first end and a second end, and a first connector at said second end;
providing a base having a second connector for connecting said base to said first connector of said sleeve and a plurality of studs;
providing a plurality of clamp bricks having a first bed with studs, and a second bed with recesses, said studs being capable of receipt into said recesses to interconnect said bricks to form an external decorative sleeve;
assembling said bricks to form said outer sleeve said assembling step includes the steps of creating a starter course of clamp bricks on said base by selecting a first group of clamp bricks from said plurality of clamp bricks, said first group of clamp bricks corresponding to said starter course, positioning a brick over said studs and inserting said studs into said recesses and repeating until said starter course is complete;
creating a second course of bricks over said starter course by selecting a second group of clamp bricks from said plurality of clamp bricks, positioning a brick over said studs of said bricks in said starter course and inserting said studs into said recesses and repeating until said second course is complete; repeating creating courses of bricks until said decorative external sleeve is assembled;
inserting said sleeve into said external sleeve;
connecting said base to said sleeve.

10. The method of claim 9, wherein said first and second connectors are threaded;
said step of connecting said base to said sleeve includes the step of threading said first and second connectors together.

11. The method of claim 9 wherein said sleeve has a rim and said rim has a recess, said step of inserting said sleeve into said external sleeve includes the step of inserting said studs of the uppermost bricks of said external sleeve into said recess.

12. The method of claim 9 wherein said external sleeve has images and said step of assembling said bricks includes selecting and positioning bricks with images to correctly form said image.

13. The method of claim 12 wherein said step of assembling said external sleeve includes the step of assembling said bricks a running bond style wherein said bricks are staggered by ½ brick from the course above and below, in a one-over-two pattern.

14. A cup comprising:
a sleeve having a hollow closed interior, a first end and a second end, and a first connector at said second end;
a base having a second connector for connecting said base to said first connector of said sleeve;
said first and second connectors have mating threads configured to be threaded and mate together to connect said sleeve to said base;
an external decorative sleeve defined by a plurality of clamp bricks having a first bed with studs, and a second bed with recesses, said studs being configured to be inserted into said recesses to interconnect said bricks to form said external decorative sleeve;
said clamp bricks have an inner stretcher face and an outer stretcher face with said inner stretcher face being concave and said external stretcher face being convex, said inner stretcher case and outer stretcher face also being tapered between said first bed and second bed.

15. The cup of claim 14, wherein said clamp bricks each have opposed ends, said opposed ends are angled inwardly from said outer stretcher face to said inner stretcher face.

16. The cup of claim 14, wherein said sleeve has a rim at said first end.

17. The cup of claim 16, wherein said rim has a recess capable of accepting said studs of said clamp bricks.

18. The cup of claim 14, further including an image on said external stretcher face of at least one of said clamp bricks.
